(19) United States
(12) Patent Application Publication
(10) Pub. No.: US 2026/0169154 A1
(43) Pub. Date: Jun. 18, 2026

(54) SYSTEM AND METHOD FOR GENERATING ECHO TRAILS OF MOVING OBJECTS FOR A SET OF PULSE WIDTHS

(71) Applicant: FURUNO ELECTRIC CO., LTD., Nishinomiya-City (JP)

(72) Inventor: Yamato YOSHIKAWA, Nishinomiya (JP)

(73) Assignee: FURUNO ELECTRIC CO., LTD., Nishinomiya-City (JP)

(21) Appl. No.: 19/534,816

(22) Filed: Feb. 10, 2026

Related U.S. Application Data
(63) Continuation of application No. PCT/JP2023/029748, filed on Aug. 17, 2023.

(51) Int. Cl. G01S 13/89; G01S 7/06; G01S 7/292

(52) U.S. Cl. CPC G01S 13/89; G01S 7/06; G01S 7/292

(57) ABSTRACT

The present disclosure provides a system and a method for generating echo trails for a plurality of predefined selectable pulse widths. An antenna receives echo information of source waves at a vessel, from a targeted object. An echo image generator is configured to generate a plurality of processed echo information sets from the received echo information. The received echo information corresponds to a first pulse width of the echo trail. The plurality of processed echo information sets comprising a plurality of echo trails of the target object is stored in at least one storage. An echo trail of the plurality of echo trails is selected by a selector based on a second pulse width set by a user. A synthesizer synthesizes a display output based on the selected echo trail.

### CROSS-REFERENCE TO RELATED APPLICATION(S)

This application is a bypass continuation of International Application No. PCT/JP2023/029748, filed on Aug. 17, 2023. The entire contents of the above applications are incorporated herein by reference.

### TECHNICAL FIELD

The present disclosure generally relates to object detection techniques and, more particularly, relates to an apparatus and a method for generating echo trails of moving objects for a plurality of predefined selectable pulse widths.

### BACKGROUND

Moving bodies in the marine environment such as vessels, ships, barges, boats, etc. are typically used for the transportation of people and goods among other various applications, across the globe. Apparatuses used in the detection, ranging, and monitoring, such as Radio Detecting and Ranging (RADAR) and Sound Navigation and Ranging (SONAR) systems, installed on-board the moving bodies or stationary monitoring stations are used to identify moving and stationary objects in a marine environment. Such apparatuses transmit electromagnetic (in RADAR) or sound pressure (in SONAR) waves, sweeping the marine environment for other objects or bodies. The electromagnetic or sound pressure waves are reflected from a target object, for example, a target ship or a vessel. The reflected electromagnetic or sound pressure waves received by the aforementioned apparatuses are called echoes. The echoes are generally considered as signals carrying information about the distance, speed, direction, location, heading, etc. of the target object. Using the echo information, the location, the direction, the translational speed, etc. of the target object can be determined by the concerned apparatuses, such as the RADAR or the SONAR.

The location of the target object may further be displayed with an echo trail on a display screen. The echo trail is a technique used to provide visual representations of motion (for example, path and speed) of surrounding moving bodies by superimposing several received echoes from several respective RADAR or SONAR scans. Information such as the traveling direction and speed of the moving bodies can be obtained and displayed in a substantially real-time environment. The echo trails can be of great assistance to an observer in making real-time assessments of maritime traffic within a predefined vicinity of the observer, whether the observer is on a vessel or a barge, or they are at the stationary monitoring station. The echo trail can either be relative or true. The relative echo trails show relative movement between the observer and the target object. The relative echo trails give an early indication of the collision risk that exists. Further, the relative echo trails when combined with true vectors indicate the relative movement of the target object such as the other vessels. The true echo trails present true target movements depending on the speed and the course of the target object. The duration of the echo trail can be adjusted as per the requirement of the observer. For example, the user (e.g. observer of the display screen) can set the period over which the target object needs to be monitored, in other words, the duration of the echo trail to be displayed can be set by the observer. The observer can also set one of the pulse widths over which the target object needs to be monitored. The pulse width refers to a time period between the leading and trailing edges of a single pulse of energy. The electromagnetic or sound pressure waves reflected from a target object are a function of the peak energy of the pulse, the pulse width, and the pulse repetition frequency. Based on the newly set pulse width, the echo trail and echo of the target object are displayed on the display screen.

The systems and methods, in the state of the art, for generating and displaying echo trails, suffer from several deficiencies. For instance, when the pulse width is changed by the observer, it is difficult to judge the echo trails of the newly set pulse width, as the echo trail may partially disappear or get degraded for a certain period. In that regard, several solutions have been suggested to at least partially address the aforementioned deficiencies.

United States Patent No. U.S. Pat. No. 7,768,447B2 discloses methods and apparatuses to process sensing signals. A method includes recording a sensing image sensed at a first detection range and outputting the sensing image to a display. The method further includes recording additional information displayed on a screen and outputting additional information to the display. When the first detection range is or has been changed to a second detection range, a new image from the recorded sensing image is computed using an image manipulation computer function, so that the computed image fits a new scale of the second detection range. The computed image is recorded. The computing changes to the recorded additional information to adjust the additional information to the new scale of the changed range and record the computed additional information. In this method even though the additional information is added to the new scale, degradation and disappearance of the echo trail will occur due to the time involved in processing the additional information. Further, in this method, the trail deteriorates each time when the display area is changed repeatedly. In some cases, the trail becomes discontinuous due to different settings, for example, pulse width, used by different display areas.

FIG. 1A shows a block diagram of processing circuitry 100 for processing echo information 102 in a conventional RADAR apparatus, in accordance with the conventional art. The echo received from a target object (not shown in FIG. 1) by an antenna 104 comprises the echo information 102 indicating the distance, speed, direction, location, etc. of the target object. A storage 106 stores the received echo information 102 and the synthesizer 108 synthesizes a display output 110 comprising the echo and the echo trail. The display output 110 is displayed on a display 112. When the observer changes a display parameter such as the display range, a width of the echo trail, a time period of the echo trail, etc., the echo trail would likely have an inconsistent (or discontinuous) width on the display 112. The RADARs are configured to scale (enlarge/shrink) or clear the stored echo trails when a pulse width is changed by the user. Therefore, degradation in terms of image quality and/or disappearance of portions of the echo trails altogether may occur, making it difficult for the observer to objectively examine the information provided by the echo trails immediately after the pulse width has been changed.

FIG. 1B illustrates a schematic representation of display output (e.g. 120, 130, 140) comprising an echo trail and an echo in a conventional RADAR apparatus, in accordance with the conventional art. By changing the pulse width of the transmitted electromagnetic waves, the width of the received echo changes. In conventional RADARs, previously stored echo trails are not rescaled to the new pulse width, causing temporary coexistence of trails with different widths and impairing immediate judgment. In this method, the echo trail 122 of the previously set pulse width will appear along with an echo trail of the newly set pulse width. The echo trail 122 of the previous set pulse width will disappear over a period of time. Therefore, due to the simultaneous display of two echo trails, judging the situation of the target object will be difficult until the echo trail 122 of the previous pulse width disappears. The pulse width refers to a time period between the leading and trailing edges of a single pulse of energy. The electromagnetic waves reflected from a target object are a function of the peak energy of the pulse, the pulse width, and the pulse repetition frequency. An increase in the pulse width increases the amount of energy reflected off from the target and thereby increases the range at which an object can be detected.

As shown in FIG. 1B, the display output 120 represents an echo trail image having the echo trail 122 and the echo 124 of the target object. The display output 120 corresponds to a current pulse width (for a preset display range) in a display. When the user changes the pulse width to a new pulse width, there exists degradation and disappearance of echo trail images in the display output 120. For example, when the pulse width is increased, as shown in the display output 130, the echo trail image will illustrate a new echo 134 with echo trails 122 and 132. The echo trails 122 and 132 represent the echo trails of the previous pulse width and the new pulse width, respectively. When the pulse width is decreased, as shown in the display output 140, the echo trail images will have a new echo 144 with echo trails 122 and 142. The echo trails 122 and 142 represent the echo trails of the previous pulse width and the new pulse width, respectively. The position of the antenna in the display outputs 120, 130, and 140 is also shown in the FIG. 1B. Thus, instead of displaying the echo and echo trail of the selected pulse width alone, the echo and echo trail of the previously set pulse width is also shown on the display. This creates difficulty in tracking and locating the target object.

Therefore, there exists a need for techniques to reduce the occurrences of degradation and disappearance of echo trail images and to make it easier for the observer to judge the situation immediately after the pulse width is changed, in addition to providing other technical advantages.

### SUMMARY

In order to solve the foregoing problem and to provide other advantages, one aspect of the present disclosure is to provide a method that includes receiving, by an antenna, echo information of a plurality of source waves at a vessel, from a targeted object. The method further includes generating a plurality of processed echo information sets from the received echo information. The plurality of processed echo information sets correspond to a plurality of predefined selectable pulse widths and a display range set by a user. The method further includes storing the plurality of processed echo information sets. The plurality of processed echo information sets comprises a plurality of echo trails corresponding to the plurality of predefined selectable pulse widths (for a preset display range) of the target object. The method further includes selecting an echo trail of the plurality of echo trails from the storage based on a second pulse width set by a user (e.g. observer of the display). The second pulse width is set from a plurality of predefined selectable pulse widths. The method further includes synthesizing a display output based on the selected echo trail.

In an aspect, the method further includes displaying the display output comprising the selected echo trail.

In an aspect, the method further includes accepting the second pulse width set by the user.

In an aspect, the method further includes setting the second pulse width by the user comprises changing the first pulse width to the second pulse width.

In an aspect, the method further includes processing the echo information to generate the plurality of processed echo information sets for the plurality of predefined selectable pulse widths based on the received echo information.

In an aspect, the method further includes generating the plurality of processed echo information sets from the received echo information for an arbitrary pulse width selected from a plurality of predefined selectable pulse widths.

In an aspect, the method further includes generating a verification dataset comprising the plurality of processed echo information sets and the received echo information.

In an aspect, the method further includes generating the plurality of processed echo information sets by one or more steps of scaling, filtering, matching, linearly interpolating, and linearly extrapolating the echo information.

In an aspect, a system of generating echo images is disclosed. The system includes an antenna configured to receive echo information of a plurality of source waves of a first pulse width, at a vessel, from a targeted object. The system also includes an echo image generator configured to generate a plurality of processed echo information sets from the received echo information. The plurality of processed echo information sets correspond to a plurality of pulse widths and a display range set by a user. The system also includes a storage configured to store the plurality of processed echo information sets. The plurality of processed echo information sets comprises a plurality of echo trails of the target object. The system also includes a selector configured to select an echo trail of the plurality of echo trails from the storage based on a second pulse width set by a user. The second pulse width is set from a plurality of predefined selectable pulse widths. The system also includes a synthesizer configured to generate the display output based on the selected echo trail.

In an aspect, the system further includes a display configured to display the display output comprising the selected echo trail.

In an aspect, the system further includes a user interface configured to accept the second pulse width set by the user.

In an aspect, the user changes the first pulse width to the second pulse width.

In an aspect, the echo image generator is further configured to process the echo information to generate the plurality of processed echo information sets for the plurality of predefined selectable pulse widths based on the received echo information.

In an aspect, the echo image generator is further configured to generate the plurality of processed echo information sets from the received echo information for an arbitrary pulse width selected from a plurality of predefined selectable pulse widths.

In an aspect, the echo image generator is further configured to generate the plurality of processed echo information sets by performing one or more steps of scaling, filtering, matching, linearly interpolating, and linearly extrapolating the echo information.

In an aspect, the synthesizer is further configured to generate a verification dataset comprising the plurality of processed echo information sets and the received echo information.

In an aspect, a system of generating echo images is disclosed. The system includes an antenna configured to receive echo information of a plurality of source waves of a first pulse width, at a vessel, from a targeted object. The system also includes processing circuitry configured:
to generate a plurality of processed echo information sets from the received echo information,
to store the plurality of processed echo information sets, wherein the plurality of processed echo information sets comprises a plurality of echo trails of the target object,
to select an echo trail of the plurality of echo trails from the storage based on a second pulse width set by a user, the second pulse width is set from a plurality of predefined selectable pulse widths, and
to generate the display output based on the selected echo trail.

In an aspect, the system further includes a display configured to display the display output comprising the selected echo trail.

In an aspect, the system further includes a user interface configured to accept the second pulse width set by the user.

In an aspect, the user changes the first pulse width to the second pulse width.

In an aspect, the processing circuitry is further configured to process the echo information to generate the plurality of processed echo information sets for the plurality of predefined selectable pulse widths based on the received echo information.

In an aspect, the processing circuitry is further configured to generate the plurality of processed echo information sets from the received echo information for an arbitrary pulse width selected from a plurality of predefined selectable pulse widths.

In an aspect, the processing circuitry is further configured to generate the plurality of processed echo information sets by performing one or more steps of scaling, filtering, matching, linearly interpolating, and linearly extrapolating the echo information.

In an aspect, the processing circuitry is further configured to generate a verification dataset comprising the plurality of processed echo information sets and the received echo information.

An advantage of various embodiments is to provide the display output that is free from degradation and disappearance of echo trail images when the pulse width is changed by the user.

The foregoing summary is illustrative only and is not intended to be in any way limiting. In addition to the illustrative aspects, embodiments, and features described above, further aspects, embodiments, and features will become apparent by reference to the drawings and the following detailed description.

The present disclosure provides a system and a method for generating echo trails are disclosed. Echo information received from several RADAR or SONAR scans is used to generate echo trails of target objects, such as surrounding vessels, for several distinct pulse widths. The generated echo trails may then be stored in the storage. When a pulse width is changed from one distinct value to another distinct value, the stored echo trail for the newly set pulse width value is selected from the stored echo trails and displayed on a display to reduce the occurrences of degradation and disappearance of echo trail images and to make it easier for an observer to monitor the environment in the vicinity of the observer, without a significant delay or latency after the pulse width is changed. In that regard, the observer may be located on a movable barge or a movable vessel, or the observer may be located at the stationary maritime monitoring station or the like. The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings are included to provide a further understanding of the present disclosure and are incorporated in and constitute a part of this specification. The drawings illustrate an exemplary embodiment of the present disclosure and, together with the description, serve to explain the principles of the present disclosure. It should be noted that in the accompanying drawings, like or same reference numerals refer to identical or functionally-similar elements throughout the separate views and which are incorporated in and form a part of the specification, further illustrate the disclosed embodiments and, together with the detailed description of the disclosure, serve to explain the principles of the disclosed embodiments.

The diagrams are for illustration only, which thus is not a limitation of the present disclosure. Moreover, those skilled in the art will understand that the drawings are not to scale.

FIG. 1A illustrates a simplified block diagram of processing circuitry for the processing of the echo in a conventional RADAR apparatus, in accordance with conventional art;

FIG. 1B illustrates a schematic representation of an echo and an echo trail in a conventional RADAR apparatus, in accordance with the conventional arts;

FIG. 2A illustrates an example representation of an environment related to at least some example embodiments of the present disclosure;

FIG. 2B illustrates another example representation of the environment of FIG. 2A related to at least some example embodiments of the present disclosure;

FIG. 3 illustrates a simplified block diagram of the sensing apparatus, in accordance with an embodiment of the present disclosure;

FIG. 4 illustrates a schematic representation of various inputs to processing circuitry of the sensing apparatus, in accordance with an embodiment of the present disclosure;

FIG. 5 illustrates a schematic representation of echoes received for a plurality of predefined selectable pulse widths, in accordance with an embodiment of the present disclosure;

FIG. 6 illustrates a simplified block diagram of processing circuitry for the processing of the echo in the sensing apparatus, in accordance with an embodiment of the present disclosure;

FIG. 7 illustrates a schematic diagram showing example processes involved in the processing circuitry for the processing of the echo in the sensing apparatus, in accordance with an embodiment of the present disclosure;

FIG. 8A and FIG. 8B illustrate example representations of an echo with echo trail of received echo information and processed echo information respectively, in accordance with an embodiment of the present disclosure;

FIG. 8C illustrates an example representation of an echo with echo trail of processed echo information of conventional sensing apparatus; and

FIG. 9 illustrates a flow diagram of a method for generating echo images of one or more target objects, in accordance with an embodiment of the present disclosure.

### DESCRIPTION OF EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are outlined in order to provide a thorough understanding of the embodiments of the present disclosure. It will be apparent to those skilled in the art that embodiments of the present disclosure may be practiced without some of these specific details. It should be understood that the particular values and configurations discussed in the following non-limiting examples can be varied and are cited merely to illustrate at least one embodiment and are not intended to limit the scope thereof.

The present disclosure relates to system and methods for generating echo trails of moving objects for a plurality of predefined selectable pulse widths. A system that may be located on-board a vessel or at a stationary monitoring station in the middle of the ocean or at the shore, receives echo information including several echoes from a target object, and performs processing of echo information, for example, scaling, enlarging, shrinking, linearly interpolating, etc. The echo information of the received echoes is processed to generate several processed echo information sets corresponding to several predefined pulse widths. The generated processed echo information sets are stored in a storage. When the pulse width is changed by a user from one value to another, an echo trail stored in a storage, for the newly set value of the pulse width, is retrieved and displayed on the display. This reduces the occurrences of degradation and disappearance of echo trail images due to changes in pulse widths and allows the user to easily evaluate the environment surrounding the vessel without any significant delay or latency after the pulse width is changed. It should be noted that the pulse width is changed from the current pulse width of the echo trail to one of a plurality of predefined selectable pulse widths.

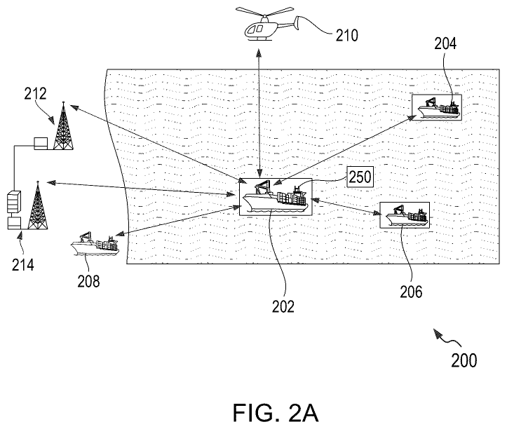

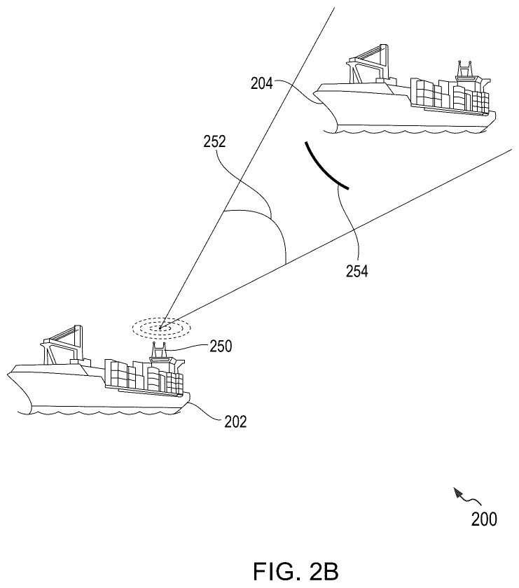

A plurality of predefined selectable pulse widths corresponds to a display range previously set by the observer. Thus, for currently set display range, the set of the echo trails corresponding the plurality of predefined selectable pulse widths are stored in the storage. When the pulse width is changed by the observer from one selectable value to another, the echo trail of the newly set pulse width can be easily retrieved from the storage and a display output of the newly set pulse width, comprising the echo and echo trail is displayed on the display. The plurality of predefined selectable pulse widths is not limited to small, medium, or large width sizes (e.g. S1, S2, M1, M2, M3, L1) of the transmitted source waves (e.g. electromagnetic waves) and the display range is not limited to, for example, 1.5 NM, 3 NM, 12 NM, etc., where NM represents Nautical Miles, over which the target object needs to be monitored. Various embodiments of the present disclosure are described hereinafter with reference to FIG. 2A, FIG. 2B to FIG. 9.

It should be noted that, in the present disclosure, the storage can store one or more pulse width(s) for the display range set by the user. Based on the received echo information, the set of echo trails corresponding the one or more pulse width(s) and the previously set display range are generated by processing circuitry of the sensing apparatus and stored in the storage. When the pulse width is changed from one selectable value to another, the echo trail of the newly set pulse width can be retrieved from the storage and displayed to the observer.

It should be noted that the term “echo trails” is interchangeably referred to as “a plurality of echo trails”, “a plurality of potential echo trails”, “a plurality of processed echo information sets”, etc. Similarly, the term “pulse widths” are interchangeably referred to as “a set of pulse widths”, “a plurality of pulse widths”, etc.

FIG. 2A illustrates an example representation of an environment 200 related to at least some example embodiments of the present disclosure. Environment 200 is for example, a marine environment 200 comprising one or more watercraft (e.g., a vessel) configured to sail in water bodies (e.g., sea). Environment 200 includes one or more objects 202, 204, 206, 208, and 210. The environment 200 also includes a communication base station 212 and a communication network station 214. The communication base station 212 and the communication network station 214 are at least wireless connections with each one of one or more objects 202, 204, 206, 208, and 210. In that regard, for generating echo trails any one of the communication base station 212, the communication network station 214, and the one or more objects 202, 204, 206, 208, and 210 may act as an observation station and the rest of the one or more objects 202, 204, 206, 208, and 210 may act as the target objects. For example, if any one of the communication base station 212 and the communication network station 214 acts as an observation station, then all of the one or more objects 204, 206, 208, and 210 will act as the target objects. Alternately, if anyone (for example, a vessel 202) of the one or more objects acts as the observation station, the rest of the one or more objects 202, 204, 206, 208, and 210, i.e., the objects 204, 206, 208, and 210 will act as target objects for generating echo trails. However, the communication base station 212 and the communication network station 214 may not be considered to be target objects as they are envisaged to be stationary locations with respect to an inertial frame of reference.

In that regard, the observation station (for example, the vessel 202) may be equipped with a sensing apparatus 250. The sensing apparatus 250 may be selected from a group consisting Radio Detecting and Ranging (RADAR) and Sound Navigation and Ranging (SONAR) apparatus. The sensing apparatus 250 is used to identify moving objects (e.g., vessels 204, 206, and an aircraft 210) and stationary objects (e.g., a vessel 208), and other systems (not shown) in the marine environment.

The vessel 202 may be associated with the communication base station 212 and the communication network station 214. The communication base station 212 and the communication network station 214 can be communicably coupled to the vessel 202 either through wired or wireless communication.

The communication base station 212 serves as a central connection point for a wireless device to communicate. The communication base station 212 has a fixed transceiver and acts as a main communication point for one or more moving objects (e.g., vessels 204, 206, and an aircraft 210), stationary objects (e.g., a vessel 208), and other systems (not shown) in the marine environment 200. The communication base station 212 can have one or more receive/transmit antenna, microwave dish, electronic circuitry, etc., used to handle traffic, such as cellular traffic, data traffic, signal traffic, etc. It serves as a bridge between the communication devices, and systems in the marine environment 200, such as one or more moving objects (e.g., vessels 204, 206, and an aircraft 210), stationary objects (e.g., a vessel 208), and other systems (not shown).

The communication network station 214 connects the communication devices, and systems in the marine environment 200. In marine environment 200, the communication devices, and systems are installed in but not limited to one or more moving objects (e.g., vessels 204, 206, and an aircraft 210), stationary objects (e.g., a vessel 208), and other systems (not shown). In one embodiment, the communication devices, and systems in the marine environment 200 include apparatuses used in the detection, ranging, and monitoring, such as RADAR and SONAR systems, installed on-board the moving bodies or stationary monitoring stations. The communication usually happens through wireless means, such as a radio channel in telecommunications and computer networking. The communication network station 214 is used for information transfer of, for example, a digital bit stream, from one or several senders to one or several receivers. The communication network station 214 has a certain capacity for transmitting information, often measured by its bandwidth in Hz or its data rate in bits per second.

The sensing apparatus 250 and other communication devices and systems in the marine environment 200 communicate with each other and also with the communication base station 212 using the communication network station 214. In some embodiments, the communication network station 214 acts as a Dual Function RADAR communication Base Station (DFBS). In the DFBS system, the communication base station 212 functions both as the central connection point for the wireless device to communicate and also acts as sensing apparatus, for example, RADAR, to receive echo signals reflected from the targets.

The sensing apparatus 250 may include one or more components configured to detect target objects (either in the static or dynamic state) present within a predetermined range of the vessel 202 (acting as the observation station) and determine one or more parameters associated with the detected target object 204. One or more parameters associated with the detected target object 204 are not limited to position information, traveling information, direction, and velocity.

FIG. 2B illustrates another example representation of the environment 200 of FIG. 2A related to at least some example embodiments of the present disclosure. The sensing apparatus 250 transmits a plurality of source waves 252 through several full circle (360 degree) sweeps. The plurality of source waves 252 reach the one or more target objects 204, 206, 208, and 210 and are reflected from the one or more target objects 204, 206, 208, and 210. The reflected waves correspond to the plurality of source waves 252, referred to as, for example, the echoes 254, received by the vessel 202 from the target object 204.

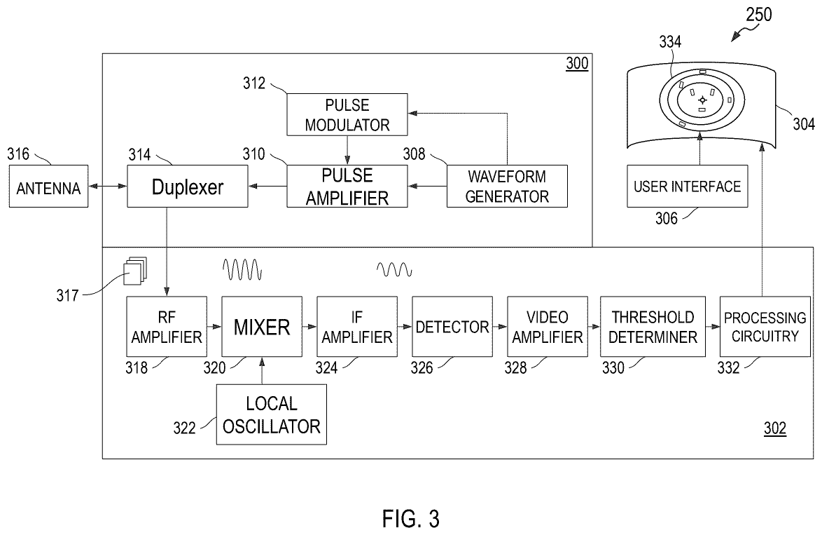

FIG. 3 illustrates a simplified block diagram of the sensing apparatus 250, in accordance with an embodiment of the present disclosure. The sensing apparatus 250 has a transmitter 300, a receiver 302, the display 304, and a User Interface (UI) 306. The transmitter 300 can be one of, but not limited to a magnetron, a traveling wave tube, or a transistor amplifier.

The transmitter 300 has a waveform generator 308 for generating a low-power source signal (for example, radio waves) (e.g., source waves 252). The source waves 252 are transmitted from the observation station (for example, the vessel 202) for detecting a target object, (for example, the target vessel 204). The signal generated by the waveform generator 308 is fed to a pulse amplifier 310. In the case of a pulse RADAR, magnetrons are widely used as transmitters but whenever there exists a need for high average power then the pulse amplifier 310 can be used.

The transmitter 300 also has a pulse modulator 312. The pulse modulator 312 turns ON and OFF the pulse amplifier 310, according to the input pulses generated by the waveform generator 308. A duplexer 314 is used to form isolation between the transmitter 300 and the receiver 302. The transmission of the source waves 252 by the transmitter 300 and reception of echoes 254 by the receiver 302 can be done using a single antenna 316, as shown in FIG. 3. The duplexer 314 allows the use of the single antenna 316 for both transmission and reception purposes. As the transmitter 300 and the receiver 302 operate at different power levels, the duplexer 314 isolates the transmitter 300 and the receiver 302. Thus, the signal from the pulse amplifier 310 is provided to the antenna 316 through the duplexer 314.

The antenna 316 also receives the echoes 254 from the one or more target objects 204, 206, 208, and 210. Information that can be extracted from echoes 254, referred to as echo information 317, may include locations, directions, and speeds of the one or more target objects 204, 206, 208. Using the echo information 317, the location, direction, and speed of the target object 204 can be calculated by the sensing apparatus 250.

An example of the receiver 302 is a superheterodyne receiver. The superheterodyne receiver is a type of radio receiver that uses frequency mixing to convert the echoes 254 to a fixed Intermediate Frequency (IF) signal which can be more conveniently processed than an original carrier frequency. The receiver 302 has a Radio Frequency (RF) amplifier 318 (e.g. low noise RF amplifier). The RF amplifier 318 acts as the input stage for the receiver 302. The RF amplifier 318 generates an RF pulse which is proportional to the echoes 254 of the source waves 252. In one embodiment, the RF amplifier 318 acts at the input stage of the receiver 302. In one another embodiment, a mixer 320 acts at the input stage by eliminating the RF amplifier 318. The mixer 320 mixes the output of the RF amplifier 318 and the output of a local oscillator 322 and the output of the mixer 320 is fed into the IF amplifier 324. In IF amplifier 324, the RF pulse received from the mixer 320 is converted into an IF signal. The IF signal generated by the mixer 320 is amplified by the IF amplifier 324. The IF amplifier 324 acts as a matched filter and increases the Signal to Noise Ratio (SNR) of the echoes 254. Also, it enhances the echo-detecting ability of the receiver 302 by reducing the effects of unwanted signals. The bandwidth of the receiver 302 is associated with the bandwidth of the IF amplifier 324.

The receiver 302 also has a detector 326 (e.g. a crystal diode) to perform demodulation of the echoes 254 by separating the source waves 252 from a carrier. A video amplifier 328 amplifies the echoes 254 to a level that can be displayed on the display 304. A threshold determiner 330 decides the existence of the target object 204 in the marine environment 200. The threshold determiner 330 is set with a threshold value that is compared with the magnitude of the source waves 252. If the threshold value is surpassed by the threshold determiner 330, then this shows the presence of the target object 204. Otherwise, it is assumed that only the noise component is present in the waves received by the antenna 316.

The display 304 shows a display output 334 of the receiver 302. The range and location of the target object 204 are displayed on the display 304, by mapping it in polar coordinates. In one embodiment, the display 304 is implemented with a Plan Position Indicator (PPI) implemented with Cathode Ray Tube (CRT). The display output 334 modulates the electron beam of the CRT to permit the electron beam to sweep from the center in the outward direction of the CRT. The sweep represents a rotation in synchronization with the pointing of the antenna 316.

The antenna 316 acts as a transceiver for transmitting source waves 252 around the vessel 202. The antenna 316 also receives the echoes 254 from the target object 204. Processing circuitry 332 processes the received echoes 254 and sends the echo information 317 (e.g. location, direction, speed of target object), to the display 304 in the form of echo images. The sensing apparatus 250 also has the UI 306 for allowing a user to input display parameters. In one embodiment, the UI 306 allows the user to change the pulse width to an arbitrary value selected from a plurality of predefined selectable pulse widths of the current echo trail in the display 304.

The sensing apparatus 250 processes the received echoes 254 of a currently-set pulse width and generates a plurality of potential echo trails for each selectable pulse width (also referred to as a “plurality of pulse widths”). The plurality of potential echo trails for each selectable pulse width is stored in a storage (not shown in FIG. 2B).

The user can select using the UI 306, a pulse width from the plurality of pulse widths. Based on the display parameter (i.e., pulse width) set by the user, the display output of the target object 204 is adjusted in the display 304. The plurality of predefined selectable pulse widths is a set of pulse widths that can be selectable using the sensing apparatus 250. An example of the plurality of pulse width is not limited to, a plurality of pulse widths, such as S1, S2, M1, M2, M3, L1 (for example, S1 and S2 represent short pulse width range, M1, M2, and M3 represent middle pulse width range and L1 represent long pulse width range, where S1<S2<M1<M2<M3<L1). Based on the selected pulse width, the display output (e.g., echo and echo trail) of the targeted object is displayed on the display 304.

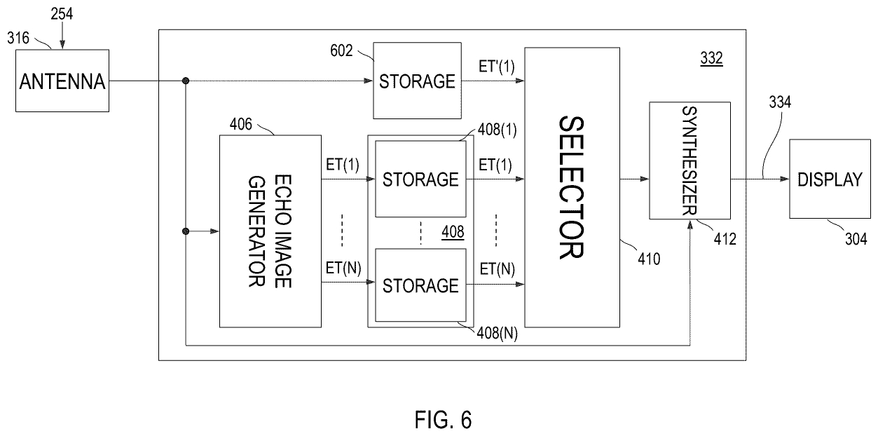

In one embodiment of the disclosure, the processing circuitry 332 generates a plurality of processed echo information sets from the received echo information 317. The received echo information 317 corresponds to a first pulse width of the current echo trail in the display 304. The first pulse width represents the current pulse width of the echo trail in the display 304. The user, using the UI 306 can change the pulse width by selecting a new pulse width from the plurality of pulse widths. The new pulse width selected by the user represents a second pulse width. That is the user using the UI 306 changes the pulse width from the first pulse width to the second pulse width. The detailed steps of processing of echo by the processing circuitry 332 are depicted in FIG. 6.

The sensing apparatus 250 is configured to locate the objects (e.g., the target vessels 204, 206, 208, and 210) present within the predetermined area of the vessel 202 based on receipt of the reflected source waves (e.g. echoes 254) being intercepted by the target vessels (e.g., the target vessels 204, 206, 208, and 210). Moreover, the sensing apparatus 250 is configured to determine the coordinates of the target vessels (e.g., the target vessels 204, 206, 208, and 210) and the distance between the vessel 202 and each of the target vessels (e.g., the target vessels 204, 206, 208, and 210). The distance between the vessel 202 and the target vessels (e.g., the target vessels 204, 206, 208, and 210) is computed based on the time measured between the transmission of the source waves 252 and receipt of the echoes 254. From the received echoes 254, echo information 317 such as locations, directions, and speeds of the one or more target objects (e.g., the target vessels 204, 206, 208, and 210) can be extracted by the sensing apparatus 250. More specifically, the processing circuitry 332 is capable of processing the echoes 254 and extracting locations, directions, and speeds of the one or more target objects (e.g., the target vessels 204, 206, 208, and 210) from the echoes 254.

The processing circuitry is further configured to generate a plurality of processed echo information sets from the received echo information 317. The received echo information 317 corresponds to a first pulse width of the current echo trail in the display 304. The plurality of processed echo information sets comprising a plurality of echo trails of the target object (e.g. vessel 204) is stored in at least one storage (not shown in FIG. 3). An echo trail of the plurality of echo trails is selected by a selector (not shown in FIG. 3) based on a second pulse width set by a user. A synthesizer (not shown in FIG. 3) synthesizes the display output 334 based on the selected echo trail. When a pulse width is changed from one distinct value to another distinct value, the stored echo trail for the newly set pulse width value is selected from the stored echo trails and displayed on the display 304. This reduces the occurrences of degradation and disappearance of echo trail images displayed on the display 304.

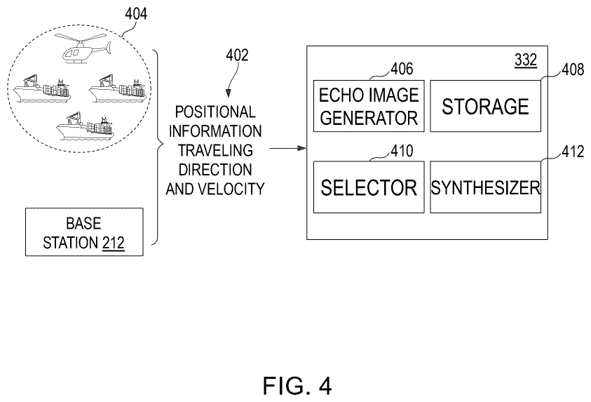

FIG. 4 illustrates a schematic representation of various inputs 402 (e.g., position information, traveling information, direction, and velocity) to the processing circuitry 332 of the sensing apparatus 250, in accordance with an embodiment of the present disclosure. The echo information 317 is received by the sensing apparatus 250 of the vessel 202 from a plurality of target objects 404 (e.g., moving vessels 204, 206, stationary vessel 208, and aircraft 210). The sensing apparatus 250 also receives data from or sends data to the communication base station 212. The echo information 317 includes but is not limited to inputs 402 of one or more of the target objects (204, 206, 208, or 210). The processing circuitry 332 has an echo image generator 406, a storage 408, a selector 410, and a synthesizer 412.

The echo image generator 406 is configured to generate a plurality of processed echo information sets from the received echoes 254. The plurality of processed echo information sets correspond to the plurality of pulse widths (also referred to as the plurality of predefined selectable pulse widths”) and a display range set by the user. The received echo information 317 corresponds to a first pulse width of the current echo trail in the display 304. The plurality of processed echo information sets comprising a plurality of echo trails of the target object (e.g. 204) is stored in the storage 408. The echo trail of the plurality of echo trails is selected by a selector 410 based on the second pulse width set by the user. The synthesizer 412 synthesizes the display output 334 based on the selected echo trail. The synthesizer 412 generates a verification dataset comprising the plurality of processed echo information sets and the received echo information 317.

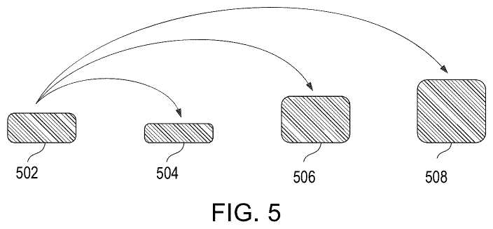

FIG. 5 illustrates a schematic representation of echoes (502, 504, 506, and 508) received for a plurality of predefined selectable pulse widths (M1, S2, M2, and M3), in accordance with an embodiment of the present disclosure. The display 304 can be configured in two or more display ranges, for example, Range R1, Range R2, and Range R3. The user may set a display range, for example, Range R1, and a pulse width, for example, M1. For the display range R1, the observer can change from the current pulse width (also referred to as the “first pulse width”) to the new pulse width (also referred to as the “second pulse width”, e.g. S2, M2, M3). For example, if the first pulse width is M1 (where S2<M1<M2<M3), the observer can change the pulse width from M1 to S2. The observer can also change the pulse width from M1 to S2 or from M1 to M3. As the display range remains constant for the given plurality of predefined selectable pulse widths, in the display output 334 only the width of the echo and echo trail is changed as per the new pulse width set by the observer. As shown in FIG. 5, the echo 502 represents the echo received for the pulse width M1 (i.e. first pulse width) set by the user. The echo 504, 506, and 508 represent the echoes generated (e.g. processed echo information) for respective pulse widths S1, M2, and M3. User can change from the pulse width M1 (i.e. first pulse width) to at least one of the pulse widths S1, M2, and M3 (i.e. second pulse width).

FIG. 6 illustrates a simplified block diagram of the processing circuitry 332 for the processing of the echo information 317 in the sensing apparatus 250, in accordance with an embodiment of the present disclosure. It should be noted that for simplicity the processing of the echo information 317 in the receiver 302 is omitted and FIG. 6 mainly describes about the processing of the echo information 317 in the processing circuitry 332. The processing circuitry 332 has an echo image generator 406 for processing the echo information 317 received by the antenna 316. The echo image generator 406 generates a plurality of processed echo information sets from the received echo information 317. The processed echo information sets represent a plurality of echo trails ET(1) to ET(N) (where N is the integer) and each corresponds to the plurality of the pulse widths. The plurality of echo trails ET(1) to ET(N) is generated based on the received echo information 317. Thus, depending on the configuration of at least the sensing apparatus 250 and setting (e.g. pulse width and the display range) in the display 304, the plurality of echo trails ET(1) to ET(N) of the target object 204 is generated by the echo image generator 406.

The processing circuitry 332 has one or more storages, for example, a storage 602 and the plurality of storages 408 (also referred to as “storages 408”). The storage 602 stores the echo trail ET′(1) corresponding to the current pulse width, that is, the first pulse width. The plurality of storages 408 can be, for example, storages 408(1) to 408(N) (where N is an integer). The echo image generator 406 generates the plurality of echo trails ET(1) to ET(N) based on the received echo information 317. Each of the generated plurality of echo trail ET(1) to ET(N) of the target object 204 corresponds to a selectable pulse width in the processing circuitry 332. Each of the generated plurality of echo trail ET(1) to ET(N) of the target object 204 is stored in respective storages 408(1) to 408(N). The plurality of echo trail ET(1) to ET(N) for a plurality of predefined selectable pulse widths may correspond to a display range preset by the observer.

When the user changes the pulse width, that is from the first pulse width to the second pulse width, using the UI 306, the corresponding echo trail (one of the echo trails ET(1) to ET(N)) stored in the corresponding storage (e.g. one of the storages 408(1) to 408(N)) is selected by a selector 410. The echo trail (one of the echo trails ET(1) to ET(N)) selected based on the second pulse width (that is, the newly set pulse width) is displayed as the display output 334 on the display 304.

It should be noted that the plurality of pulse widths is predefined depending on the device specification of at least one of the sensing apparatus 250 and the display 304. The device specification is not limited to the working range of sensing apparatus 250, the processing speed of the processing circuitry 332 and the echo image generator 406, the frequency of the source wave from the waveform generator 308, etc.

A synthesizer 412 displays the display output 334 based on the selected echo trail. It should be noted that the display output 334 comprises the echo information 317 and the echo trail selected based on the new pulse width. Thus, the delay, degradation, and disappearance of the echo trail at the time of changing the pulse width (for example, from the first pulse width to the second pulse width) can be avoided, as the echo trail of the selected pulse width is already stored in the one of the storages 408(1) to 408(N) and the same can be easily retrieved and displayed on the display 304. In one embodiment of the disclosure, the storage 408(1) to 408(N) stores a plurality of widths of the respective echo trails ET(1) to ET(N). The echo trails ET(1) to ET(N) corresponds to the plurality of predefined selectable pulse widths of the source wave of the sensing apparatus 250 (e.g. RADAR apparatus).

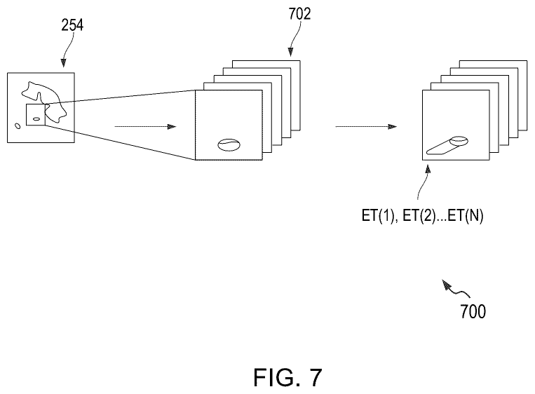

FIG. 7 illustrates a schematic diagram showing example processes 700 involved in the processing circuitry 332 for the processing of the echoes 254 in the sensing apparatus 250, in accordance with an embodiment of the present disclosure. From the echo information 317 (obtained from the echoes 254) received from the target object (e.g. 204), the processing circuitry 332 processes a plurality of echo information 702 for each pulse width. The plurality of echo information 702 for all the pulse widths is generated by the processing circuitry 332 from the received echo information 317. As the echo trails ET(1) to ET(N) for all the pulse widths for the received echo trail is readily available in the respective storages 408(1) to 408(N), the echo trail of user selected pulse width is immediately shown on the display 304 without delay. This reduces the occurrences of degradation and disappearance of echo trail images and makes it easier to judge the situation immediately after the pulse width is changed.

Some of the processing performed by the echo image generator 406 for each selectable pulse width is not limited to the following one or more steps:
Echo scaling: This includes enlarging or shrinking the echoes for each selectable pulse width Image filtering: To smooth the echo after echo scaling
Echo size processing: To match the corresponding pulse width set per display range
Echo size processing may include without limitation, linear interpolation and linear extrapolation. Linear interpolation is a method useful for building new data points within the range of a discrete set of already-known data points. Thus, a new pulse width between the known pulse widths can be found using linear interpolation. Linear extrapolation creates a tangent line at the end of the known data and extends it beyond that limit. Thus, a new pulse width beyond known pulse widths can be found using linear extrapolation. This allows the sensing apparatus 250 to be operated in more selectable, predefined pulse widths.

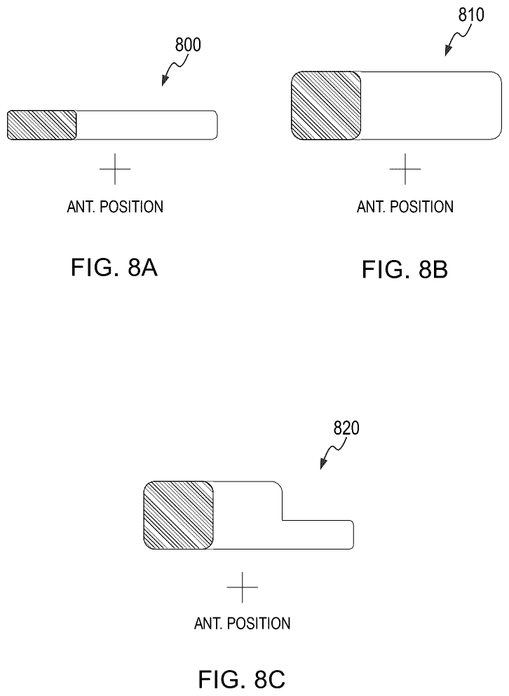

FIG. 8A and FIG. 8B illustrate example representations of an echo with echo trail of received echo information and processed echo information respectively, in accordance with an embodiment of the present disclosure. In FIG. 8A and FIG. 8B, the pulse width is changed from M1 to M3. The display output 800 represents the echo trail at the pulse width of M1. The display output 810 represents the echo trail at the pulse width of M3 (after changing from M1). It is evident that there exists no degradation and disappearance of echo trail images and this makes it easier for the observer to judge the situation of the target object immediately after the pulse width is changed.

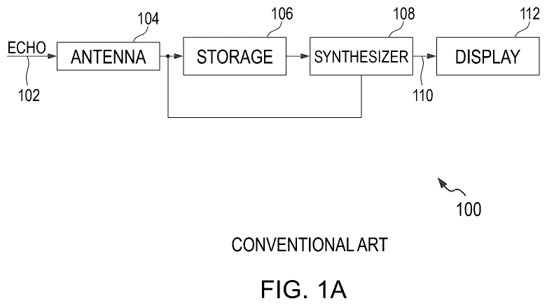

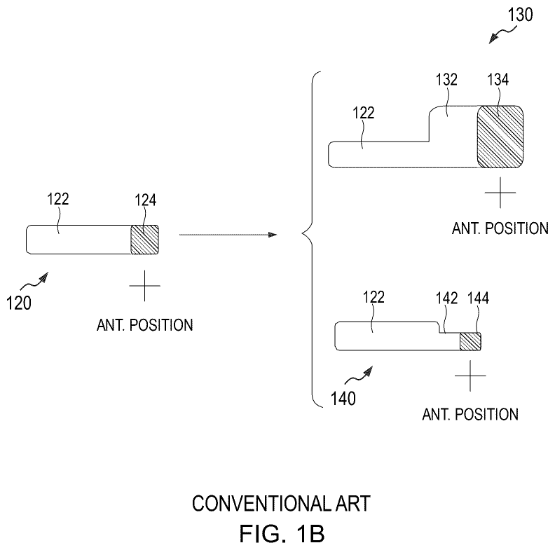

FIG. 8C illustrates example representations of an echo with echo trail of processed echo information of conventional sensing apparatus. The display output 820 represents the echo trail at the pulse width of M3 (after changing from M1) in the conventional method (Refer to FIG. 1B). It is evident that the pulse width of M1 appears along with the pulse width of M3 of echo trail images and this makes it hard for the observer to judge the situation of the target object. The position of the antenna (e.g. antenna 316) in the display outputs 800, 810, and 820 is also shown in the FIG. 8A to FIG. 8C.

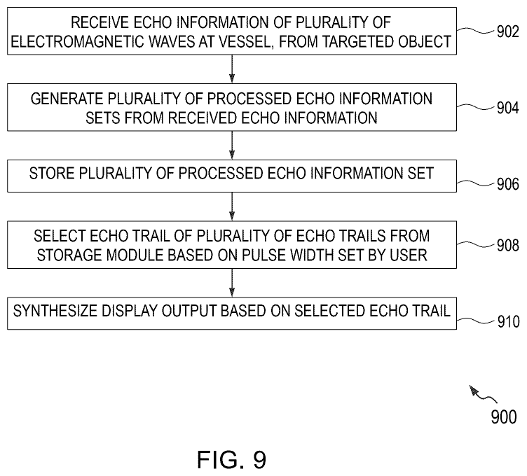

FIG. 9 illustrates a flow diagram of a method 900 generating echo images, in accordance with an embodiment of the present disclosure. Operations of the flow diagram of the method 900, and combinations of the operations in the flow diagram of the method 900, may be implemented by, for example, hardware, firmware, a processing circuitry, and/or a different device associated with the execution of software that includes one or more computer program instructions. The sequence of operations of the method 900 may not be necessarily executed in the same order as they are presented. Further, one or more operations may be grouped and performed in the form of a single step, or one operation may have several sub-steps that may be performed in parallel or a sequential manner. The method 900 starts at operation 902.

At operation 902, the method 900 includes receiving, by an antenna 316, echo information 317 of a plurality of source waves 252 at a vessel 202, from a targeted object 204.

At operation 904, the method 900 includes generating, by the echo image generator 406, a plurality of processed echo information sets from the received echo information. The received echo information 317 corresponds to a first pulse width of the echo trail. The echo image generator 406 processes the echo information 317 to generate the plurality of processed echo information sets for the plurality of predefined selectable pulse widths based on the received echo information. In one embodiment the echo image generator 406 processes the plurality of processed echo information sets from the received echo information for an arbitrary pulse width selected from a plurality of predefined selectable pulse widths. The arbitrary pulse width can be selected from a plurality of predefined selectable pulse widths by the user. In another embodiment generating the plurality of processed echo information sets comprises one or more steps of scaling, filtering, matching, linearly interpolating, and linearly extrapolating the echo information.

At operation 906, the method 900 includes storing, by the storage 602, 408, the plurality of processed echo information sets. The plurality of processed echo information sets comprises the plurality of echo trails ET(1) to ET(N) of the target object 204.

At operation 908, the method 900 includes selecting, by the selector 410, an echo trail of the plurality of echo trails ET(1) to ET(N) from a storage of the storage 602, 408 based on a second pulse width set by the user. The second pulse width is set from a plurality of predefined selectable pulse widths. The observer using the user interface 306 can change from the first pulse width to the second pulse width. The selector 410 selects the echo trail of the newly set pulse width from the plurality of echo trails ET(1) to ET(N).

At operation 910, the method 900 includes synthesizing, by the synthesizer 412, the display output 334 based on the selected echo trail. The echo and echo trail of the newly set pulse width is synthesized and displayed to the observer on the display 304. In one embodiment, a verification dataset comprising the plurality of processed echo information sets and the received echo information 317 is generated by the processing circuitry or the echo image generator.

The disclosed methods with reference to FIG. 9, or one or more operations of the apparatus 250 may be implemented using software including computer-executable instructions or machine-readable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a Multi-function device (MFD), Multi-function device black box (MFD-BB), a navigation device, a chart plotter, electronic chart display and information system (ECDIS), a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the present disclosure has been described with reference to specific exemplary embodiments, it is noted that various modifications and changes may be made to these embodiments without departing from the broad spirit and scope of the present disclosure. For example, the various operations, blocks, etc., described herein may be enabled and operated using hardware circuitry (for example, Complementary Metal-Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the echo image generator 406 among other components of the apparatus 250 may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable (CD-R), Compact Disc Rewritable (CD-R/W), Digital Versatile Disc (DVD), BD (BLU-RAY (R) Disc), and semiconductor memories (such as mask ROM, programmable ROM (PROM), Erasable PROM (EPROM), flash memory, Random Access Memory (RAM), etc.).

Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media.

Examples of transitory computer-readable media include electric signals, optical signals, and electromagnetic waves. Transitory computer-readable media can provide the program to a computer via a wired communication line (e.g., electric wires, and optical fibers) or a wireless communication line.

Thus, the echo image generator 406 allows no degradation and disappearance of echo trail images when the pulse width is changed by the user. Further, the present disclosure allows the observer to easily judge the situation of the target object immediately after the pulse width changed.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, multiple processors or processor cores, or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, state machine, combination of the same, or the like. A processor can include electrical circuitry configured to process computer-executable instructions. In another embodiment, a processor includes an application-specific integrated circuit (ASIC), a field programmable gate array (FPGA), or other programmable devices that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can”, “could”, “might” or “may”, unless specifically stated otherwise, are otherwise understood within the context as used in general to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z”, unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements, or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations”, without other modifiers, typically means at least two recitations or two or more recitations).

It will be understood by those within the art that, in general, terms used herein, are generally intended as “open” terms (e.g., the term “including” should be interpreted as “including but not limited to”, the term “having” should be interpreted as “having at least”, the term “includes” should be interpreted as “includes but is not limited to”, etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above”, “below”, “bottom”, “top”, “side”, “higher”, “lower”, “upper”, “over”, and “under”, are defined with respect to the horizontal plane.

As used herein, the terms “attached”, “connected”, “mated” and other such relational terms should be construed, unless otherwise noted, to include removable, moveable, fixed, adjustable, and/or releasable connections or attachments. The connections/attachments can include direct connections and/or connections having an intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method for generating echo images, comprising:
receiving echo information of a plurality of source waves of a first pulse width, at a vessel, from a targeted object
generating a plurality of processed echo information sets from the echo information, the plurality of processed echo information sets correspond to a plurality of pulse widths and a display range set by a user;
storing the plurality of processed echo information sets, wherein the plurality of processed echo information sets comprises a plurality of echo trails of the target object;
selecting an echo trail of the plurality of echo trails based on a second pulse width set by a user, the second pulse width set from a plurality of predefined selectable pulse widths; and
synthesizing a display output based on the selected echo trail.

2. The method of claim 1, further comprising:
displaying the display output comprising the selected echo trail.

3. The method of claim 1, further comprising:
accepting the second pulse width set by the user.

4. The method of claim 3, wherein:
setting the second pulse width by the user comprises changing the first pulse width to the second pulse width.

5. The method of claim 1, further comprising:
processing the echo information to generate the plurality of processed echo information sets for the plurality of predefined selectable pulse widths based on the echo information.

6. The method of claim 5, further comprising:
generating the plurality of processed echo information sets from the echo information for an arbitrary pulse width.

7. The method of claim 1, wherein:
generating a verification dataset comprising the plurality of processed echo information sets and the received echo information.

8. A system for generating echo images, comprising:
an antenna configured to receive echo information of a plurality of source waves of a first pulse width, at a vessel, from a targeted object;
an echo image generator configured to generate a plurality of processed echo information sets from the echo information, the plurality of processed echo information sets correspond to a plurality of pulse widths and a display range set by a user;
a storage configured to store the plurality of processed echo information sets, wherein the plurality of processed echo information sets comprises a plurality of echo trails of the target object;
a selector configured to select an echo trail of the plurality of echo trails from the storage based on a second pulse width set by a user, the second pulse width set from a plurality of predefined selectable pulse widths; and
a synthesizer configured to synthesize a display output based on the selected echo trail.

9. The system of claim 8, further comprising:
a display configured to display the display output comprising the selected echo trail.

10. The system of claim 8, further comprising:
a user interface configured to accept the second pulse width set by the user.

11. The system of claim 8, wherein:
the echo image generator is further configured to process the echo information to generate the plurality of processed echo information sets for the plurality of predefined selectable pulse widths based on the echo information.

12. The system of claim 11, wherein:
the echo image generator is further configured to generate the plurality of processed echo information sets from the echo information for an arbitrary pulse width.

13. The system of claim 8, wherein:
the echo image generator is further configured to generate the plurality of processed echo information sets by performing one or more steps of scaling, filtering, matching, linearly interpolating, and linearly extrapolating the echo information.

14. A system for generating echo images, comprising:
an antenna configured to receive echo information of a plurality of source waves of a first pulse width, at a vessel, from a targeted object; and
processing circuitry configured
to generate a plurality of processed echo information sets from the echo information, the plurality of processed echo information sets correspond to a plurality of pulse widths and a display range set by a user;
to store the plurality of processed echo information sets, wherein the plurality of processed echo information sets comprises a plurality of echo trails of the target object;
to select an echo trail of the plurality of echo trails from the storage based on a second pulse width set by a user, the second pulse width set from a plurality of predefined selectable pulse widths; and
to synthesize a display output based on the selected echo trail.

15. The system of claim 14, further comprising:
a display configured to display the display output comprising the selected echo trail.

16. The system of claim 14, further comprising:
a user interface configured to accept the second pulse width set by the user.

17. The system of claim 14, wherein:
the second pulse width is set by the user, by changing the first pulse width to the second pulse width.

18. The system of claim 14, wherein:
the processing circuitry is further configured to process the echo information to generate the plurality of processed echo information sets for the plurality of predefined selectable pulse widths based on the echo information.

19. The system of claim 18, wherein:
the processing circuitry is further configured to generate the plurality of processed echo information sets from the echo information for an arbitrary pulse width.

20. The system of claim 14, wherein:
the processing circuitry is further configured to generate the plurality of processed echo information sets by performing one or more steps of scaling, filtering, matching, linearly interpolating, and linearly extrapolating the echo information.
